(19) United States
(12) Patent Application Publication
(10) Pub. No.: US 2011/0265520 A1
(43) Pub. Date: Nov. 3, 2011

(54) Methods For Determining The Rotational Characteristics Of An Optical Fiber

(76) Inventors: Xin Chen, Corning, NY (US); Brett Jason Hoover, Middlebury Center, PA (US); Ming-Jun Li, Horseheads, NY (US); Anping Liu, Big Flats, NY (US); Jody Paul Markley, Watkins Glen, NY (US)

(21) Appl. No.: 12/769,288

(22) Filed: Apr. 28, 2010

(51) Int. Cl. G01N 23/20

(52) U.S. Cl. 65/378

(57) ABSTRACT

A method for determining a rotational characteristic of an optical fiber is disclosed. The method includes forming an orientation registration feature in an optical fiber preform and drawing an optical fiber from the preform such that the orientation registration feature formed in the optical fiber preform is imparted to the optical fiber. The optical fiber is then rotated about a longitudinal axis and the direction of rotation is periodically reversed. An orientation signal of the optical fiber is determined based on a position of the orientation registration feature as the optical fiber is rotated. A rotational characteristic of the optical fiber is then determined based on the orientation signal.

### BACKGROUND

1. Field

The present specification generally relates to methods for spinning or twisting optical fibers to reduce polarization mode dispersion and, more specifically, to methods for determining the rotational characteristics of an optical fiber during spinning and/or twisting of an optical fiber.

2. Technical Background

Spinning or twisting an optical fiber as the optical fiber is drawn from an optical fiber preform has been found to reduce the polarization mode dispersion (PMD) of the optical fiber. Spinning an optical fiber refers to the process of rotating an optical fiber about a longitudinal axis of the optical fiber while the optical fiber is molten while twisting refers to the process of rotating an optical fiber about a longitudinal axis of the optical fiber after the optical fiber has cooled and solidified. The “spin” imparted to an optical fiber from spinning is permanently fixed in the optical fiber as the optical fiber cools and solidifies. However, the “twist” imparted to an optical fiber from twisting may be transitory, that is, the optical fiber may become “untwisted.”

In order to effectively reduce PMD in an optical fiber, the spin/twist profile, which is defined as the spin/twist rate as a function of the position of the optical fiber, must be substantially symmetric around the zero spin rate. In other words, PMD is most effectively reduced when the spinning/twisting motion imparted to the optical fiber does not yield a net accumulation of spin or twist along the length of the optical fiber, meaning that the rotation of the optical fiber in a clockwise direction is equal to the rotation of the optical fiber in the counter-clockwise direction along the entire length of the optical fiber. As such, it is important to control the spin/twist imparted to the optical fiber to prevent a net accumulation of spin or twist along the optical fiber.

Accordingly, a need exists for alternative methods for the in situ measurement of the rotational characteristics of an optical fiber which may be used to control the spin and/or twist imparted to the optical fiber.

### SUMMARY

According to one embodiment, a method of determining a rotational characteristic of an optical fiber includes forming an orientation registration feature in an optical fiber preform. An optical fiber is then drawn from the optical fiber preform such that the orientation registration feature formed in the optical fiber preform is imparted to the optical fiber. The optical fiber is then rotated about a longitudinal axis and the direction of rotation is periodically reversed. An orientation signal of the optical fiber is determined based on a position of the orientation registration feature as the optical fiber is rotated. First and second rotational regions are determined and a first number of fringes n_{A} is determined within the first rotational region while a second number of fringes n_{B} is determined in the second rotational region. A rotational characteristic of the optical fiber is then determined based on the first number of fringes n_{A} in the first rotational region and the second number of fringes n_{B} in the second rotational region. The rotational characteristic may be at least one of the rotational offset of the optical fiber or the rotational magnitude of the optical fiber.

In another embodiment, a method of determining a rotational characteristic of an optical fiber includes forming an orientation registration feature in an optical fiber preform and drawing an optical fiber from the optical fiber preform such that the orientation registration feature formed in the optical fiber preform is imparted to the optical fiber drawn from the optical fiber preform. Thereafter, the optical fiber is rotated about a longitudinal axis of the optical fiber as the direction of rotation of the optical fiber is periodically reversed. An orientation signal of the optical fiber is determined based on a position of the orientation registration feature as the optical fiber is rotated. A local rotational rate of the optical fiber is determined based on the orientation signal.

Additional features and advantages of the invention will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A schematically depicts a portion of an optical fiber preform according to one or more embodiments shown and described herein;

FIG. 1B schematically depicts one embodiment of a cross section of the optical fiber of FIG. 1A with an orientation registration feature according to one or more embodiments shown and described herein;

FIG. 1C schematically depicts one embodiment of a cross section of the optical fiber of FIG. 1A with an orientation registration feature according to one or more embodiments shown and described herein;

FIG. 1D schematically depicts one embodiment of a cross section of the optical fiber of FIG. 1A with an orientation registration feature according to one or more embodiments shown and described herein;

FIG. 2 schematically depicts a fiber drawing system according to one or more embodiments shown and described herein;

FIG. 3 schematically depicts the change in the radius of an optical fiber with an oval cross section as the optical fiber is rotated about a longitudinal axis;

FIG. 4 schematically depicts an apparatus for determining the rotational orientation of an optical fiber according to one or more embodiments shown and described herein;

FIG. 5A graphically depicts diffraction patterns produced by an optical fiber with a notch orientation registration feature for different angular orientations of the notch;

FIG. 5B graphically depicts diffraction patterns produced by an optical fiber with an oval cross section with the optical fiber at different angular orientations;

FIG. 6A graphically depicts an exemplary integrated rotational profile of an optical fiber according to one or more embodiments shown and described herein;

FIG. 6B graphically depicts an orientation signal of an optical fiber as a function of the position along the optical fiber according to one or more embodiments shown and described herein;

FIG. 6C graphically depicts an orientation signal of an optical fiber as a function of the position along the optical fiber according to one or more embodiments shown and described herein;

FIG. 7 graphically depicts an orientation signal of an optical fiber utilized to determine the rotational rate of the optical fiber according to one or more embodiments shown and described herein;

FIG. 8 graphically depicts an orientation signal of an optical fiber according to one example described herein;

FIG. 9 graphically depicts an orientation signal of an optical fiber according to one example described herein; and

FIG. 10 graphically depicts an orientation signal of an optical fiber according to one example described herein.

### DETAILED DESCRIPTION

Reference will now be made in detail to various embodiments of methods for determining the rotational characteristics of an optical fiber. The methods generally comprise forming an orientation registration feature in an optical fiber preform and drawing an optical fiber from the preform such that the orientation registration feature is imparted to the optical fiber. The optical fiber is rotated as it is drawn from the preform and the direction of rotation is periodically reversed. An orientation signal is determined from the rotating optical fiber utilizing the position of the orientation registration feature and, based on the orientation signal, at least one rotational characteristic of the optical fiber is determined. The rotational characteristic may be utilized to adjust the rotation of the optical fiber and thereby optimized the polarization mode dispersion of the optical fiber. The method for determining the rotational characteristics of an optical fiber will be described in more detail herein with specific reference to the appended figures.

The term “spin,” as used herein, refers to the rotation introduced into a molten optical fiber about the longitudinal axis of the optical fiber. As the fiber is cooled, the spin is permanently fixed in the fiber.

The term “twist,” as used herein, refers to the rotation introduced into a cooled optical fiber about the longitudinal axis of the optical fiber. Unlike spin, twist does not become permanently fixed in the fiber.

Based on the foregoing definitions, it should be understood that spin and twist represent the rotation imparted to an optical fiber at different stages of the optical fiber manufacturing process. However, it should also be understood that the methods described herein may be used to identify the rotational characteristics of an optical fiber regardless of whether such characteristics are due to “spin” or to “twist”. Accordingly, in describing the various embodiments of the method for determining the rotational characteristics of an optical fiber, the term “rotation” will be used to generally refer to both “spin” and “twist”.

Further, as used herein, the term “rotational profile” is the rotational rate of the optical fiber as a function of the position z (i.e., the length) of the optical fiber. The rotational profile may be defined mathematically as:

$$α ( z ) = {α}_{0} cos ( \frac{2 π}{L} z + {φ}_{0} ) + {α}_{off} ,$$

where α₀ is the rotational magnitude, L is the rotational period, and α_{off} is the rotational offset. Integrating the rotational profile with respect to z yields the integrated rotational profile which is defined as:

$$θ ( z ) = \frac{{α}_{0} L}{2 π} ( sin ( \frac{2 π}{L} z + {φ}_{0} ) - sin ( {φ}_{0} ) ) + {α}_{off} z .$$

The integrated rotational profile yields the angular orientation of the optical fiber θ(z) as a function of the position z of the optical fiber as the optical fiber is drawn from an optical fiber preform and rotated. As noted herein, the rotational characteristics of the optical fiber (i.e., the rotational magnitude, the rotational offset, the rotational period, etc.) may be adjusted as the optical fiber is formed in order to minimize PMD in the optical fiber. The methods described herein utilize an orientation signal collected from an optical fiber with an orientation registration feature to determine the rotational characteristics of the optical fiber without having to determine the rotational profile or the integrated rotational profile of the optical fiber. While the aforementioned equations relate to sinusoidal rotational profiles, it should be understood that the methods described herein are equally applicable to non-sinusoidal rotational profiles.

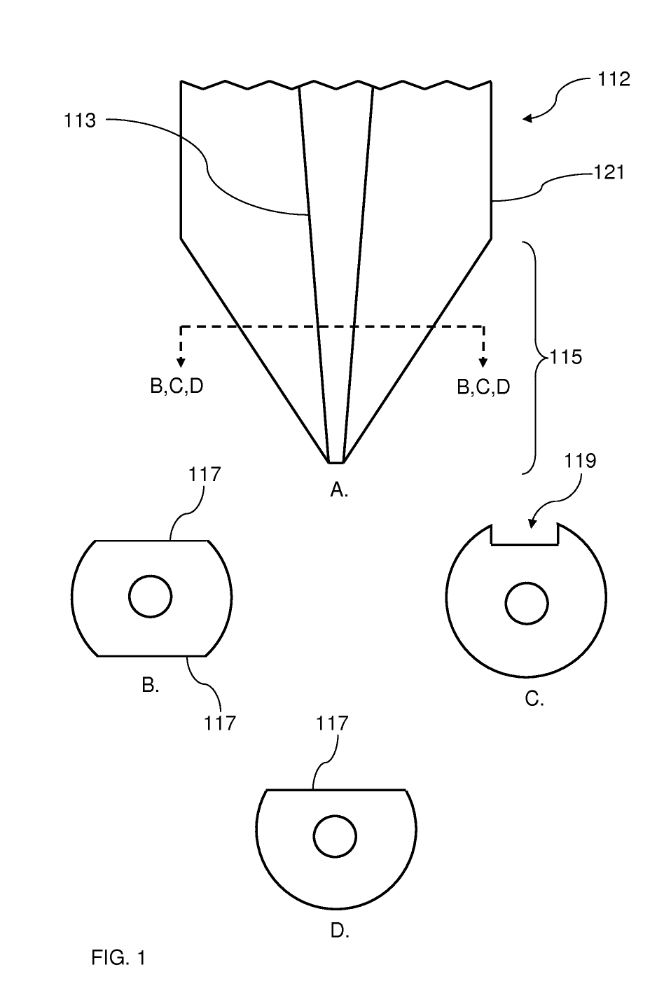

Referring now to FIGS. 1A-1D, FIG. 1A schematically depicts a portion of an optical fiber preform 112 which is used in conjunction with the methods of determining the rotational characteristics of an optical fiber described herein. The optical fiber preform 112 generally comprises a central core region 113 surrounded by a cladding region 121. The core region 113 and the cladding region 121 generally comprise silica-based glass. In some embodiments, the core region 113 and the cladding region 121 include dopants which increase or decrease the refractive index of the silica-based glass relative to pure silica glass.

As illustrated in FIG. 1, the optical fiber preform 112 terminates in a tapered region 115. In the embodiments described herein, the tapered region 115 includes one or more orientation registration features formed in the optical fiber preform 112. FIGS. 1B-1D depict cross sections through the tapered region 115 of the optical fiber preform 112 illustrating various embodiments of registration features which may be formed in the preform. For example, in the embodiment depicted in FIG. 1B, the orientation registration feature comprises a pair of opposed flats 117 that may be machined into the tapered region 115 of the optical fiber preform 112. In this embodiment, the flats 117 are substantially parallel with one another. However, it should be understood that, in other embodiments, the flats 117 may be non-parallel. In one embodiment, after the orientation registration features have been formed in the optical fiber preform, the optical fiber preform has an aspect ratio of approximately 0.72 through a cross section of the optical fiber preform where the orientation registration features are formed. In another embodiment, the optical fiber preform has an aspect ratio of approximately 0.985 through a cross section of the optical fiber preform where the orientation registration features are formed. Accordingly, it will be understood that a fiber drawn from the preform will have a similar aspect ratio as that of the preform. The term aspect ratio, as used herein, refers to the ratio of the shortest diameter of the cross section to the longest diameter of the cross section. It should be understood that the aspect ratio of the optical fiber preform may have a value other than 0.72 so long as the aspect ratio of the optical fiber preform and the aspect ratio of an optical fiber drawn from the optical fiber preform are not equal to one.

While FIG. 1B depicts an embodiment of a cross section of a tapered region 115 of an optical fiber preform 112 which utilizes a pair of opposed flats 117 as an orientation registration feature, it should be understood that, in other embodiments, a single flat may be used as an orientation registration feature. For example, FIG. 1D depicts a cross section of an optical fiber in which a single flat 117 is machined into the optical fiber preform for use as an orientation registration feature.

FIG. 1C illustrates another embodiment of a cross section through the tapered region 115 of the optical fiber preform 112 depicted in FIG. 1A. In this embodiment of the optical fiber preform 112 the orientation registration feature is formed in the tapered region of the preform as a groove 119 which is machined into the preform. In the embodiment shown in FIG. 1C, the groove has a square bottom. For example, in one embodiment, the square bottom groove 119 was formed in an optical fiber preform having an outer diameter of 46.48 mm. The groove had a depth of 3.35 mm and a width of 4.62 mm. However, it should be understood that square bottom grooves having other dimensions may also be utilized. Similarly, it should also be understood that grooves having different geometries may also be used. For example, a v-shaped groove may be formed in the optical fiber preform instead of a square bottom groove. In general, the groove 119 formed in the tapered region 115 of the optical fiber preform 112 has sufficiently large dimensions such that, when an optical fiber is drawn from the preform, the groove 119 is imparted to the optical fiber. However, it should be understood that, when the groove 119 is imparted to an optical fiber drawn from the preform, the groove on the optical fiber has smaller dimensions than the groove located on the optical fiber preform.

Generally referring to FIGS. 1A-1D, the orientation registration feature(s) formed in the optical fiber preform may be imparted to an optical fiber drawn from the preform such that the optical fiber has a readily identifiable and repeatable reference point which may be utilized to determine an orientation signal of the optical fiber as the optical fiber is drawn from the preform and rotated.

Further, it should also be noted that, in the embodiments shown herein, the orientation registration feature(s) are specifically formed in the optical fiber preform in the tapered region 115 of the optical fiber preform 112. Because optical fiber drawn from this portion of the preform is typically discarded after being drawn from the preform, locating the orientation registration feature in the tapered portion of the optical fiber preform reduces the amount of fiber which is discarded after the fiber drawing process has achieved steady state operation. However, it should be understood that, in other embodiments (not shown) the orientation registration feature may be located outside the tapered portion of the optical fiber preform, such as in a cylindrical portion of the optical fiber preform.

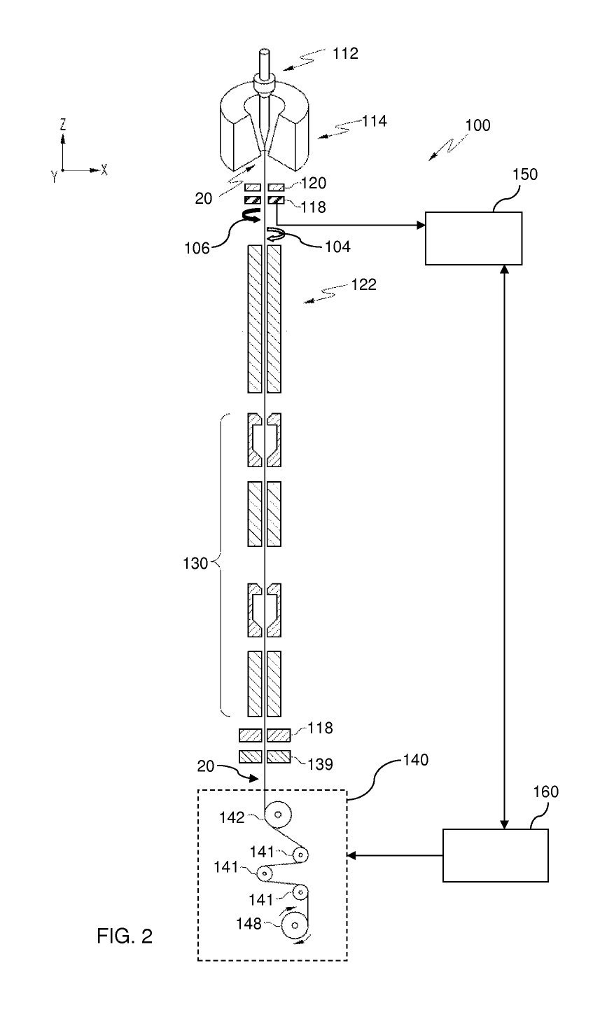

Referring now to FIG. 2, one embodiment of a system 100 for drawing optical fiber 20 from an optical fiber preform, such as the optical fiber preform with an orientation registration feature, is schematically depicted. In the embodiment depicted in FIG. 1, the system 100 generally comprises a draw furnace 114, a fiber cooling system 122, a coating system 130, and a fiber take up system 140. The optical fiber 20 is drawn from the optical fiber preform and through the various stages of the system 100 with the fiber take-up system 140. The fiber take-up system 140 utilizes various drawing mechanisms 142 and pulleys 141 to provide the necessary tension to the optical fiber 20 as the optical fiber 20 is drawn through the system 100. Moreover, in the embodiment shown in FIG. 1, the drawing mechanisms 142 and pulleys 141 of the fiber take-up system 140 may be utilized to impart rotation to the optical fiber 20 as the optical fiber is drawn through the system 100 in order to reduce PMD in the optical fiber. For example, the fiber take-up system 140 may include an assembly for imparting rotation to the optical fiber 20 as the optical fiber is drawn from the preform and periodically reversing the rotation imparted to the optical fiber. An assembly suitable for imparting rotation to the optical fiber is disclosed in U.S. Pat. No. 6,876,804. However, it should be understood that other systems suitable for imparting rotational motion to the optical fiber may also be incorporated into the fiber take-up system 140 and utilized to rotate the fiber. For example, in one embodiment (not shown) the optical fiber preform may be rotated as the optical fiber is drawn from the preform. In the embodiment shown in FIG. 2 a take-up controller 160 electrically coupled to the fiber take-up system 140 controls both the tension applied to the optical fiber and the amount and direction of rotation applied to the optical fiber 20.

As described hereinabove, the optical fiber 20 is drawn from an optical fiber preform 112 which contains one or more orientation registration features. The optical fiber is drawn from the optical fiber preform such that the orientation registration features are imparted to the optical fiber. For example, when the orientation registration feature comprises one or more flats, as described above, the optical fiber will be oval in cross section (otherwise referred to herein as “distorted” or a “distortion” from a circular cross section). When the orientation registration feature is a groove, the groove may be imparted to the optical fiber albeit at a smaller scale. In either case, the orientation registration feature imparted to the optical fiber may be utilized to determine an orientation signal of the optical fiber as the optical fiber is rotated, as will be described in more detail herein.

In the embodiment of the system 100 depicted in FIG. 2, the optical fiber 20 is drawn from the optical fiber preform with the fiber take-up system 140 and exits the draw furnace 114 along a substantially vertical pathway (i.e., a pathway along the z-direction). Simultaneously, the fiber take-up system 140 rotates the optical fiber 20 to reduce PMD in the fiber. The fiber take-up system 140 periodically reverses the direction of rotation of the optical fiber 20 such that a net accumulation of spin or twist in one direction does not occur in the optical fiber. The rotational directions of the optical fiber are schematically depicted in FIG. 2. Specifically, when viewing the optical fiber from the positive z-direction, arrow 104 depicts rotation of the optical fiber in a clockwise direction while arrow 106 depicts rotation of the optical fiber in a counter-clockwise direction.

As the optical fiber 20 exits the draw furnace 114, a non-contact flaw detector 120 is used to examine the optical fiber 20 for damage and/or flaws that may have occurred during the manufacture of the optical fiber 20. Thereafter, the diameter of the optical fiber 20 may be measured with non-contact sensor 118.

As the optical fiber is drawn along the vertical pathway, the optical fiber 20 may optionally be drawn through a cooling system 122 which cools the optical fiber 20 prior to one or more coatings being applied to the optical fiber 20. The cooling system 122 is generally spaced apart from the draw furnace 114 such that the optical fiber 20 cools to temperatures significantly below the draw temperature before entering the cooling system 122. For example, the spacing between the draw furnace 114 and the cooling system 122 may be sufficient to cool the optical fiber from the draw temperature (e.g., from about 1700° C.-2000° C.) to about 1300° C. and, more preferably, to about 1200° C. before the optical fiber 20 enters the cooling system 122. As the optical fiber 20 travels through the cooling system 122, the fiber is cooled to less than about 80° C. and, more preferably, less than about 60° C.

While a cooling system has been described herein as part of the system 100 for producing an optical fiber, it should be understood that the cooling system is optional and that, in other embodiments, the optical fiber may be drawn directly from the draw furnace to a coating system without entering a cooling system.

Still referring to FIG. 2, after the optical fiber 20 exits the cooling system 122, the optical fiber 20 enters a coating system 130 where one or more coating layers are applied to the optical fiber 20. In one embodiment described herein, the coating system 130 applies a polymeric coating layer to the optical fiber 20 through which the orientation registration feature of the optical fiber 20 is detectable after the coating has been cured. For example, when the orientation registration feature is a flat or pair of flats formed on the optical fiber preform, the polymeric coating layer may be applied to the optical fiber to a suitable thickness such that the ovality of the optical fiber is observable after application of the coating. In this embodiment it should be understood that the coating applied to the optical fiber exhibits the same distortions as the underlying optical fiber due to the registration features formed in the optical fiber.

As the optical fiber 20 exits the coating system 130, the diameter of the optical fiber 20 may be measured with non-contact sensor 118. Thereafter, a non-contact flaw detector 139 is used to examine the optical fiber 20 for damage and/or flaws in the coating that may have occurred during the manufacture of the optical fiber 20.

As described hereinabove, the orientation registration feature imparted to the optical fiber may be used to determine an orientation signal of the optical fiber as the optical fiber is drawn through the system 100. The orientation signal may be collected as function of the position (i.e., the length) of the optical fiber and may thereafter be utilized to determine the rotational characteristics of the optical fiber 20 which, in turn, may be utilized to adjust the rotation of the optical fiber.

More specifically, in the embodiment of the system 100 depicted in FIG. 2 the orientation signal of the optical fiber is determined after the optical fiber 20 exits the draw furnace 114 and before the optical fiber 20 enters the cooling system 122. In one embodiment the orientation signal is determined based on the diameter of the optical fiber 20 as measured with a non-contact sensor 118 which is positioned between the draw furnace and the cooling system 122. In this embodiment the non-contact sensor 118 is a laser micrometer or a similar measurement device capable of measuring the diameter of the optical fiber to within 0.02 microns.

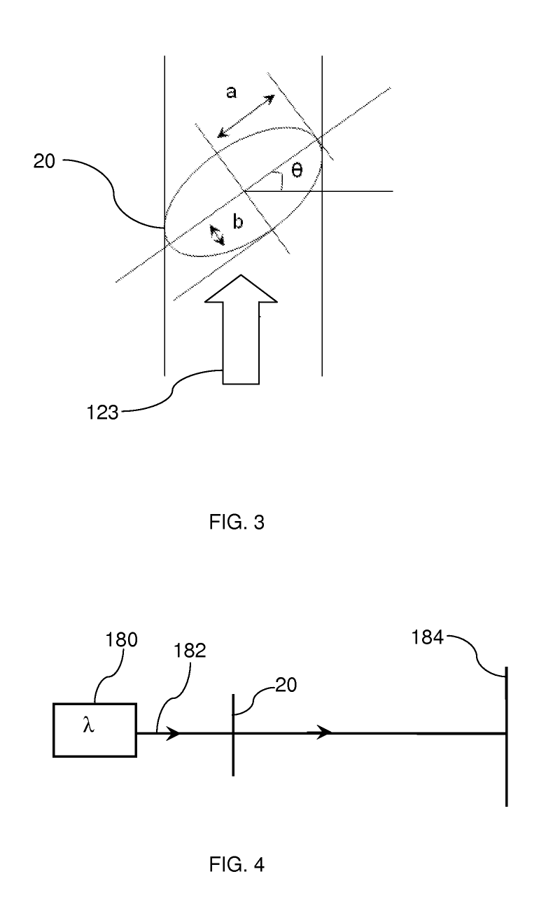

Referring now to FIGS. 2 and 3, in one embodiment, the optical fiber has an oval cross section such as when the optical fiber 20 is drawn from an optical fiber preform having orientation registration features as depicted in FIGS. 1B and 1D. For example, as the optical fiber 20 is drawn along the vertical pathway and rotated through an angle θ, the major axis a and minor axis b are alternately presented to the non-contact sensor 118. Accordingly, it should be understood that the diameter of the optical fiber varies as a function of the angle θ such that:

OD=2\sqrt{a² cos²θ+b² sin²θ}

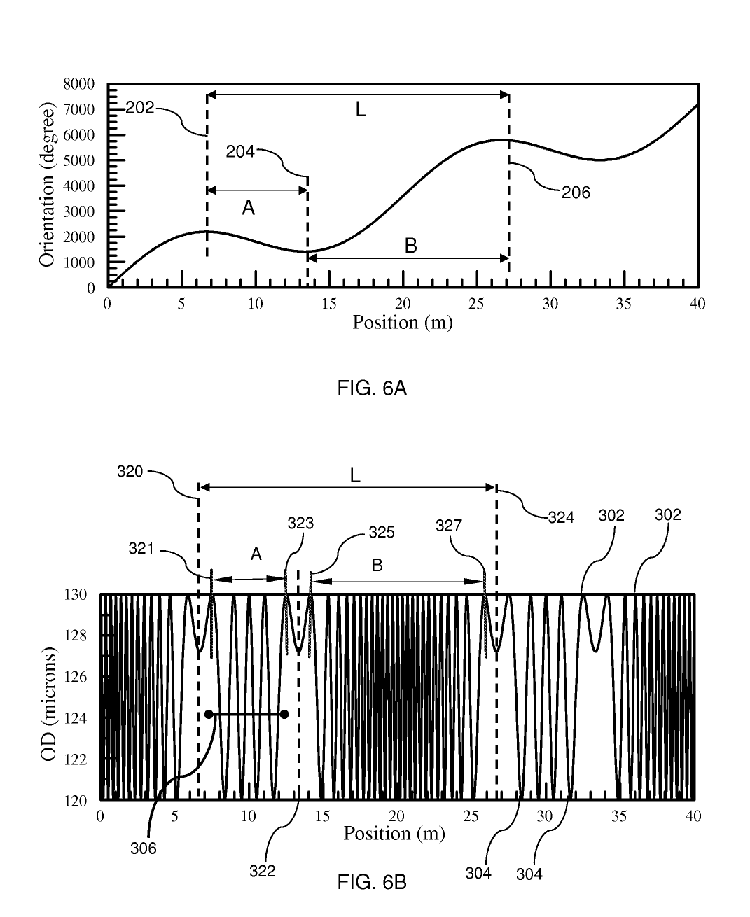

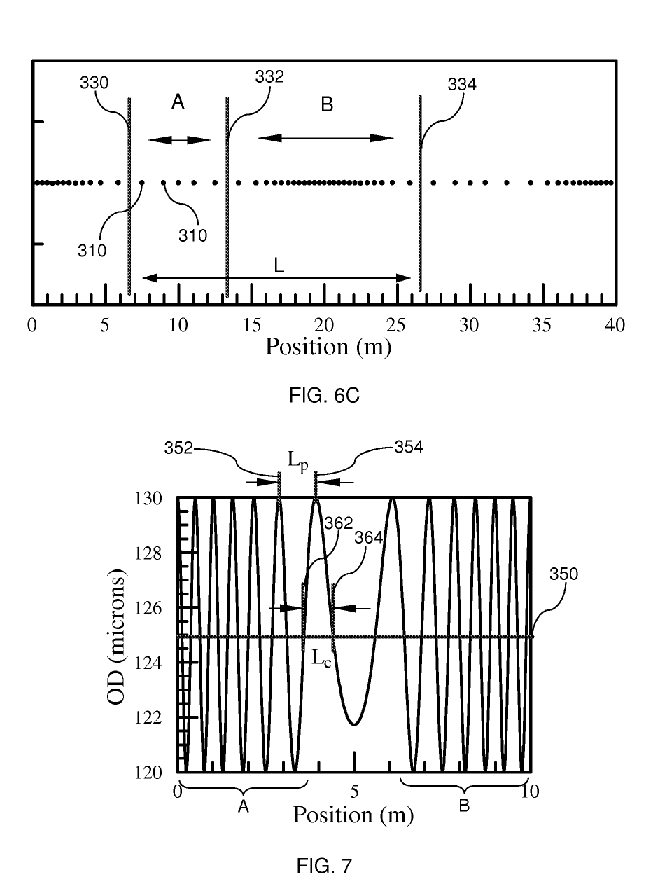

For example, when the non-contact sensor 118 is a laser micrometer, as described above, the major axis a and minor axis b are alternately presented to the beam 123 of the detector which, in turn, registers the diameter of the optical fiber 20 as fluctuating between a maximum value and a minimum value. In this embodiment, the output signal produced by the non-contact sensor 118 is indicative of the diameter of the optical fiber 20. The output signal of the non-contact sensor 118 may be transmitted to an orientation control unit 150 which is electrically coupled to both the non-contact sensor 118 and to the take-up controller 160. The orientation control unit 150 receives the output signal of the non-contact sensor 118 and, based on the draw rate of the system 100 as determined from the take-up controller 160, stores the diameter of the optical fiber 20 in a memory operatively associated with the orientation control unit 150 as a function of the position along the length of the optical fiber. FIG. 6B graphically depicts a modeled orientation signal of an optical fiber. The diameter of the optical fiber is plotted on the y-axis in microns while the position of the optical fiber is plotted on the x-axis in meters. Accordingly, it should be understood that the orientation registration feature imparted to the optical fiber from the optical fiber preform facilitates determining the orientation signal of the optical fiber as the optical fiber is rotated.

Referring now to FIGS. 1 and 4, in an alternative embodiment, the orientation signal of the optical fiber 20 may be determined by collecting a series of diffraction patterns from the optical fiber as the optical fiber is rotated. In this embodiment, the optical fiber 20 may be drawn from an optical fiber preform having a cross section as depicted in any one of FIGS. 1B-1D. As described above, the orientation signal is collected from the optical fiber between the draw furnace 114 and the cooling system 122. In this embodiment, the non-contact sensor 118 comprises a laser source 180 with a collimated beam 182 and an imaging plane 184. The imaging plane 184 may comprise one or more optical sensors (not shown) for collecting an optical signal projected on to the imaging plane 184. In an alternative embodiment (not shown) the orientation signal may be collected from the imaging plane using an optical sensor (e.g., a camera, CCD array, etc.) and subsequently analyzed using image analysis techniques.

In one embodiment, the laser source 180 comprises a He—Ne laser having an output wavelength of 632.8 nm. In this embodiment the laser source 180 may be positioned approximately 12 mm from the optical fiber 20 while the imaging plane 184 is positioned approximately 40 cm away from the optical fiber.

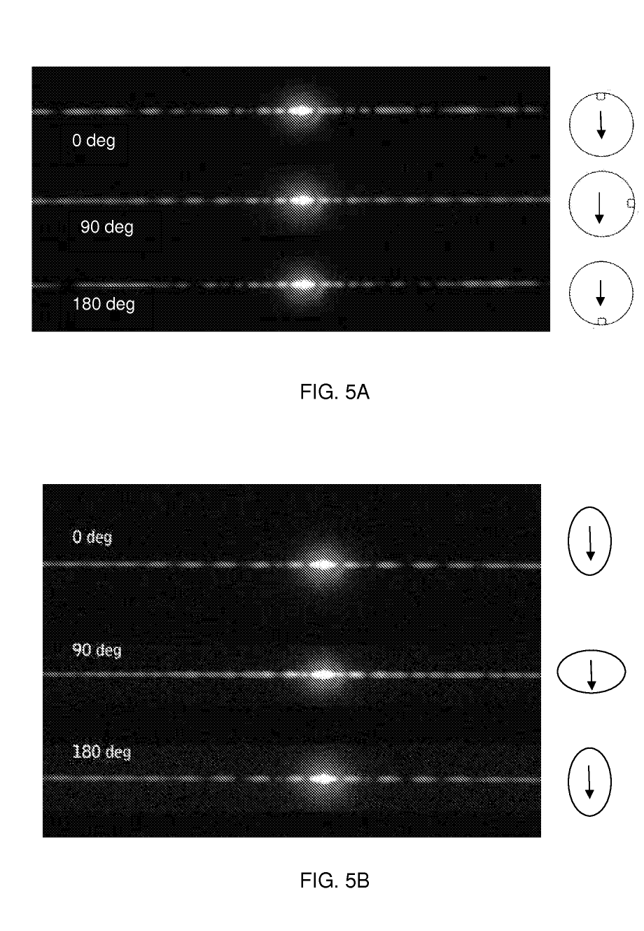

Referring now to FIGS. 1, 4 and 5A-5B, as the optical fiber 20 is drawn from the draw furnace 114 a collimated beam 182 of the laser source 180 is directed onto the optical fiber and a series of diffraction patterns are produced on the imaging plane 184. FIGS. 5A and 5B show several exemplary diffraction patterns for different angular orientations of an optical fiber with a groove orientation registration feature (FIG. 5A) and an optical fiber with a flat orientation registration feature (FIG. 5B). Accordingly, it should be understood that specific diffraction patterns may be correlated to specific orientations of the optical fiber and, as such, may be utilized to determine an orientation signal of the optical fiber. In this embodiment, the various diffraction patterns produced by the rotating optical fiber may be reduced to an output signal indicative of the varying intensity of the diffraction patterns created as the optical fiber is rotated. This electrical signal may be transmitted to the orientation control unit 150 which is electrically coupled to both the non-contact sensor 118 and to the take-up controller 160. The orientation control unit 150 receives the output signal of the non-contact sensor 118 which stores the intensity of the optical fiber 20 in a memory operatively associated with the orientation control unit 150 as a function of the position along the length of the optical fiber based on the draw rate of the system 100 as determined from the take-up controller 160. FIG. 6C graphically depicts a modeled orientation signal of an optical fiber consisting of a series of diffraction patterns of a rotating optical fiber. The peak intensities of the diffraction patterns produced by the rotating optical fiber are plotted on the y-axis in arbitrary units while the corresponding position of the optical fiber is plotted on the x-axis in meters. Accordingly, it should be understood that the orientation registration feature imparted to the optical fiber from the optical fiber preform facilitates determining the orientation signal of the optical fiber as the optical fiber is rotated.

In the embodiments described above the orientation signal is collected from the optical fiber 20 between the draw furnace 114 and the cooling system 122 while the optical fiber is in a molten state. However, it should also be understood that, in other embodiments, the orientation signal of the optical fiber 20 may be collected after the optical fiber has solidified (i.e., after the optical fiber has exited the cooling system 122) or after a coating has been applied to the optical fiber (i.e., after the optical fiber has exited the coating system 130 or after a single coating layer has been applied to the optical fiber). Thus, it should be understood that the non-contact sensor 118 utilized to obtain the orientation signal may be alternately positioned at any one of these locations.

Once the orientation signal of the optical fiber is collected, the orientation signal is analyzed to determine the rotational characteristics of the optical fiber 20 and to adjust the rotation of the optical fiber 20 imparted to the optical fiber with the fiber take-up system 140.

Referring now to FIGS. 6A-6C, 6A depicts an integrated rotational profile of an optical fiber. It should be understood that the methods described herein may be performed without constructing an integrated rotational profile for the optical fiber as depicted in FIG. 6A and that FIG. 6A is presented for purposes of discussion and explanation only. Specifically, the integrated rotational profile shown in FIG. 6A describes the angular orientation of the optical fiber on the y-axis as a function of the length of the optical fiber on the x-axis. The integrated rotational profile shown in FIG. 6A is for a modeled fiber rotation in which the rotational magnitude α₀ is 1 turn/m, the rotational period L is 20 meters, and the rotational offset α_{off} is 0.5 turns/m such that a net amount of rotation (either spin or twist) is accumulated in one direction of rotation along the length of the optical fiber. Still referring to FIG. 6A, the dashed vertical lines 202, 204, 206 are generally indicative of changes in the direction of rotation of the optical fiber. For example, in the region labeled A, the optical fiber may be rotating in a counter-clockwise direction while in the region labeled B the optical fiber may be rotating in a clockwise direction. As shown in FIG. 6A, the curve gradually increases from the left to the right indicating that some amount of rotational offset is present.

While FIG. 6A depicts an exemplary integrated rotational profile of an optical fiber in which the rotational offset is non-zero, FIG. 6B depicts a modeled orientation signal for an optical fiber rotated with the same rotational characteristics (i.e., an optical fiber with a rotational magnitude α₀ of 1 turn/m, a rotational period L of 20 meters, and a rotational offset α_{off} of 0.5 turns/m). The modeled orientation signal of FIG. 6B was determined for an optical fiber drawn from an optical fiber preform having an orientation registration feature as depicted in FIG. 1B. As the fiber rotates by half a cycle (i.e., by 180 degrees), the outer diameter of the fiber reaches a maximum value or a minimum value once. These maximum and minimum values are represented on the orientation signal as local extrema such as local maxima 302 and/or local minima 304. Accordingly it should be understood that the orientation signal depicted in FIG. 6B is based on the diameter of the optical fiber as the optical fiber is rotated. The first vertical dashed line 320 and the third vertical dashed line 324 generally indicate the rotational period L of the optical fiber which is defined as the length over which the optical fiber is rotated in both a clockwise direction for a specified number of turns and a counter-clockwise direction for a specified number of turns. In the embodiment of the orientation signal shown in FIG. 6B, the end points of the rotational period generally correspond to points where the direction of rotation of the optical fiber changes. As shown in the FIG. 6B, the orientation signal has a unique, identifiable and repeatable signature at locations where the direction of rotation of the optical fiber is reversed. In the embodiment shown in FIG. 6B, the first dashed vertical line 320 and the third dashed vertical line 324 generally indicate a unique signature in the orientation signal indicative of a change in the direction of rotation of the optical fiber.

Referring to FIG. 6C, another embodiment of a modeled orientation signal of an optical fiber is graphically depicted. In this embodiment, the orientation signal was based on an optical fiber with the same rotational characteristics as the orientation signal depicted in FIG. 6B (i.e., an optical fiber with a rotational magnitude α₀ of 1 turn/m, a rotational period L of 20 meters, and the rotational offset α_{off} of 0.5 turns/m). The orientation signal of FIG. 6C is based on a collection of diffraction patterns produced as an optical fiber with an orientation registration feature as depicted in FIG. 1B was rotated. The vertical lines 330, 334 generally indicate the rotational period L of the optical fiber which is defined as the length over which the optical fiber is rotated in both a clockwise direction for a specified number of turns and a counter-clockwise direction for a specified number of turns. In the embodiment of the orientation signal shown in FIG. 6C, the end points of the rotational period L generally correspond to points where the direction of rotation of the optical fiber changes. As shown in the FIG. 6C, the orientation signal has a unique, identifiable and repeatable signature at locations where the direction of rotation of the optical fiber is reversed. In the embodiment shown in FIG. 6C, the first vertical line 330 and the third vertical line 334 generally indicate a unique signature in the orientation signal indicative of a change in the direction of rotation of the optical fiber.

Referring to FIGS. 6B and 6C, the orientation signals may be analyzed to determine the rotational characteristics of the optical fiber without constructing an integrated rotational profile such as the integrated rotational profile depicted in FIG. 6A. In one embodiment, the analysis of the orientation signal collected from the orientation signal may be performed in real time by the orientation control unit 150. More specifically, the orientation control unit 150 may comprise a processor (not shown) communicatively coupled to a memory unit (not shown). The memory unit contains computer readable and executable instructions which are executed by the processor to analyze the orientation signal collected from a rotating optical fiber. The orientation signal may also be stored in the memory unit of the orientation control unit.

Referring to FIGS. 6B and 6C, the orientation signal is first analyzed to determine the rotational period of the optical fiber. The rotational period L of the optical fiber is the period of the minimum repeat pattern of the orientation signal. For an optical fiber having a non-zero rotational offset, the minimum repeat pattern may be determined from the unique signatures in the orientation signal that correspond to each change of the direction of rotation of the optical fiber. As described above, the rotational period L corresponds to the length of the optical fiber in which the optical fiber rotates in a first direction for a certain number of rotations and rotates in a second direction for a certain number or rotations before the direction of rotation is once again reversed. Accordingly, it should be understood that the rotational period L of the orientation signal may be determined by identifying the changes in direction of the optical fiber and, more specifically, based on the unique signatures contained in the orientation signal which correspond to changes in the direction of rotation of the optical fiber. For example, following a first change in the rotational direction, the optical fiber may rotate in a clockwise direction for a certain number of rotations at which point a second change in direction occurs. Following the second change in direction, the optical fiber rotates in a counter-clockwise direction for a certain number of rotations at which point a third change in direction occurs and the fiber once again rotates in a clockwise direction. Thereafter, the pattern of rotation is repeated. Thus, in this embodiment, the pattern of rotation is repeated after every third change in direction. The minimum repeat pattern of the optical fiber may be determined by the processor of the orientation control unit 150 by analyzing the orientation signal as a function of the position of the optical fiber and identifying the unique signature corresponding to a change in the direction of rotation of the optical fiber.

For example, referring to FIG. 6B which depicts an orientation signal of an optical fiber based on the outer diameter of the optical fiber, the rotational period L is identified by the changes in the rotational direction of the optical fiber which produce a unique signature in the orientation signal. The orientation control unit 150 may be programmed to identify the unique signature in the orientation signal corresponding to a change in the direction of rotation and, based on the repetition of this unique signature, determine the rotational period L. For example, for the orientation signal depicted in FIG. 6B, the rotational period L is the distance between first unique signature generally indicated by the first dashed vertical line 320 and the third unique signature generally indicated by the third dashed vertical line 324 on the right of the plot. In this example the rotational period L is approximately 20 meters.

Referring to FIG. 6C which depicts an orientation signal of an optical fiber based on diffraction patterns produced as the optical fiber is rotated, the rotational period L is identified by the changes in the rotational direction of the optical fiber which produce a unique signature in the diffraction patterns. Specifically, the orientation control unit 150 may be programmed to identify the unique signatures in the orientation signal corresponding to changes in the direction of rotation of the optical fiber and, based on the repetition of this unique signature, determine the rotational period L. For example, for the orientation signal depicted in FIG. 6C, the rotational period L is the distance between the first unique signature generally indicated by the first vertical line 330 and the third unique signature generally indicated by the third vertical line 334. In this example the rotational period L is approximately 20 meters.

After the rotational period L of the orientation signal is identified, a first rotational region A and a second rotational region B within the rotational period L are determined. For the orientation signals depicted in FIGS. 6B and 6C, the first rotational region A generally corresponds to the rotation of the optical fiber in a first direction while the second rotational region B generally corresponds to the rotation of the optical fiber in a second direction opposite the first direction. For example, in the first rotational region A the optical fiber may be rotated in a clockwise direction while in the second rotational region B the optical fiber may be rotated in a counter-clockwise direction.

In the embodiment of the orientation signal depicted in FIG. 6B, the first rotational region A and the second rotational region B are determined by identifying the first local extrema of the orientation signal in the rotational period L following a change in the rotational direction of the optical fiber and the local extrema immediately preceding the next change in the rotational direction of the optical fiber. For example, referring to FIG. 6B, the first rotational region A is bounded on one end by the first local maxima 321 immediately following the change in direction identified by the first dashed vertical line 320 which corresponds to a unique signature indicative of a change in the direction of rotation of the optical fiber. The first rotational region A is also bounded by the local maxima 323 immediately preceding the change in direction identified by the second dashed vertical line 322 which corresponds to a unique signature indicating a change in the direction of rotation of the optical fiber in the middle of the rotational period L. Similarly, the rotational region B is bounded on one end by the local maxima 325 immediately following the change in direction identified by the second dashed vertical line 322 which corresponds to the unique signature indicating the change of the direction of rotation of the optical fiber in the middle of the rotational period L. The second rotational region B is also bounded by the local maxima 327 immediately preceding the change in direction identified by the third dashed vertical line 324 which corresponds to a unique signature indicative of a change in the direction of rotation of the optical fiber. In the embodiment of the orientation signal depicted in FIG. 6B it should be noted that the boundaries of the first rotational region A and the second rotational region B are offset from the first local maxima within each region by a half turn of the optical fiber. However, it should be understood that, in other embodiments, the boundaries may be positioned at the local maxima without any offset.

In the embodiment of the orientation signal depicted in FIG. 6C, the first rotational region A and the second rotational region B may be determined by identifying the change in the direction of rotation of the optical fiber in the middle of the rotational period L. For example, the orientation control unit 150 may be programmed to identify the unique signature corresponding to the change in the direction of the rotation of the optical fiber within the rotational period L. In the embodiment of the orientation signal depicted in FIG. 6C, this change in the direction of rotation of the optical fiber generally corresponds to the second vertical line 332 located in the middle of the rotational period L. In the embodiment of the orientation signal depicted in FIG. 6C it should be noted that the boundaries of the first rotational region A and the second rotational region B are located at local minima. Accordingly, the first local maxima within each rotational region is offset from the boundary of each region by a half turn of the optical fiber.

After the first rotational region A and the second rotational region B have been identified, the number of fringes n_{A} in the first rotational region A are determined and the number of fringes n_{B} in the second rotational region B are determined. The number of fringes n_{A} and the number of fringes n_{B} generally correspond to the number of rotations of the optical fiber in each of the first rotational region A and the second rotational region B.

In the embodiment of the orientation signal depicted in FIG. 6B, the number of fringes n_{A} and n_{B} may be determined in a variety of ways. In one embodiment, the number of fringes in each of the first rotational region may be determined by determining the number of local maxima 302 or local minima 304 within each of the regions. For example, referring to the orientation signal depicted in FIG. 6B, the number of fringes n_{A} in the first rotational region A may be determined by counting the number of local minima 304 located within the region. For the exemplary orientation signature depicted in FIG. 6B, the number of local minima 304 in the first rotational region A is four and, as such, the number of fringes n_{A} in the first rotational region is four. Using this convention, the number of fringes n_{B} in the second rotational region B is 24.

In an alternative embodiment, the number of fringes n_{A} and the number of fringes n_{B} may be determined by counting the number of local maxima in each of the first rotational region A and the second rotational region B. In this embodiment the number of fringes n_{A} is equal to the number of local maxima in the first rotational region plus one. For example, referring to FIG. 6B, the number of local maxima 302 in the first rotational region A is three. Accordingly, the number of fringes n_{A} in the first rotational region is four (i.e., n_{A}=3 local maxima+1=4). Using this convention, the number of fringes n_{B} in the second rotational region B is 24 (i.e., n_{A}=23 local maxima+1=24).

Where the number of local maxima 302 and the number of local minima 304 are utilized to determine the number of fringes n_{A} and the number of fringes n_{B}, the orientation control unit 150 may determine the number of local maxima 302 and the number of local minima 304 by determining the change in slope of the orientation signal. For example, where the slope of the orientation signal changes direction (i.e., from a positive slope to a negative slope or vice-versa), a local maxima or a local minima is present.

In another embodiment, the number of fringes n_{A} and the number of fringes n_{B} in each of the first rotational region A and the second rotational region B may be determined by determining the number of times the orientation signal crosses a horizontal line 306 which intersects the orientation signal in either the first rotational region n_{A} and/or the second rotational region n_{B}. For example, referring to FIG. 6B, a horizontal line 306 intersects the orientation signal in the first rotational region n_{A} at an arbitrary location. The orientation signal intersects the horizontal line 306 at eight discrete points. The total number of fringes n_{A} is determined by dividing the number of intersection points by two. Accordingly, in the exemplary orientation signal depicted in FIG. 6B, the number of fringes n_{A} in the first rotational region A is 4 (i.e., n_{A}=8/2=4 fringes). A similar technique may be utilized to determine the number fringes n_{B} in the second rotational region B.

Referring to FIG. 6C, the number of fringes n_{A} and the number of fringes n_{B} in each of the first rotational region A and the second rotational region B may be determined by determining the number of local minima in the diffraction patterns in each of the first rotational region A and the second rotational region B. More specifically, the number of fringes n_{A} in the first rotational region corresponds to the number of spaces between adjacent local maxima 310 in the first rotational region A which, in the embodiment shown in FIG. 6C, is four. The number of fringes in the second rotational region B may be determined in a similar manner. In the embodiment shown in FIG. 6B the number of fringes in the second rotational region B is twenty four.

Once the rotational period L, the number of fringes n_{A}, and the number of fringes n_{B} have been determined, the orientation control unit 150 may determine a rotational characteristic of the optical fiber, such as the rotational offset and/or the rotational magnitude, based on the rotational period L, the number of fringes n_{A}, and the number of fringes n_{B}. For example, the rotational offset of the optical fiber may be determined based on the equation:

$$rotational offset = {α}_{off} = \frac{\vert {n}_{A} - {n}_{B} \vert}{2 L} .$$

The rotational magnitude of the optical fiber may also be determined based on the equation:

$$rotational magnitude = {α}_{0} = \frac{π}{4 L} \times ( {n}_{A} + {n}_{B} ) .$$

For example, in the exemplary orientation signal depicted in FIG. 6B, the orientation signal has a rotational period L=20 m. The number of fringes n_{A} in the first rotational region is 4 and the number of fringes n_{B} in the second rotational region is 24. Based on this information, the rotational offset α_{off} of the optical fiber is 0.5 turns/meter while the rotational magnitude α₀ is approximately 1 turn/meter. Similarly, in the exemplary orientation signal depicted in FIG. 6C, the orientation signal has a rotational period L=20 m. The number of fringes n_{A} in the first rotational region is 4 and the number of fringes n_{B} in the second rotational region is 24. Based on this information, the rotational offset α_{off} of the optical fiber is 0.5 turns/meter while the rotational magnitude α₀ is approximately 1.1 turns/meter. Accordingly, the calculated rotational characteristics are in good agreement with the known rotational characteristics utilized to create the modeled orientation signal shown in FIGS. 6B and 6C.

In the foregoing equations the rotational offset and the rotational magnitude are determined as a function of the rotational period L and the number of fringes n_{A} in the first rotational region and the number of fringes n_{B} in the second rotational region. However, in alternative embodiments, a relative rotational offset and a relative rotational magnitude may be determined without first determining the rotational period L. In these embodiments, the rotational period L may be set to 1 in the aforementioned equations.

As noted hereinabove with respect to FIGS. 6B and 6C, the first and last local maxima in each of the first rotational region A and the second rotational region B are offset from the actual boundaries of the region such that, when the number of fringes within each region are calculated, some fraction of half-turn rotations may be omitted from the calculation. In the case of the rotational offset, this yields an error which does not exceed 1/(2 L) turns/m where L is the rotational period of the optical fiber. In the case of the rotational magnitude, the error in the rotational magnitude increases roughly with the magnitude of the rotational offset. However, the unaccounted half-turn rotations yield an error which has an upper limit of π/(2 L) turns/meter.

Referring now to FIG. 7, in another embodiment, the orientation signal is analyzed by the orientation control unit 150 to determine other rotational characteristics of the optical fiber such as the rotational rate. In one embodiment, the local rotational rate of the optical fiber may be determined by first determining the distance Lₚ between adjacent local extrema (i.e., either local minima or local maxima) in either the first rotational region A or the second rotational region B. For example, FIG. 7 depicts a first rotational region A and a second rotational region B. The spacing Lₚ between adjacent local maxima 352, 354 may be determined and the local rotational rate of the optical fiber in rotational region A may be calculated according to the equation:

$$spin rate = \frac{π}{{L}_{p}} .$$

Alternatively, the local rotational rate may be determined by determining the spacing L_{c} between two adjacent crossing points 362, 364 at a certain cross level indicated by the solid line 350. The local rotational rate in the region may then be calculated according to the equation:

$$spin rate = \frac{π}{{L}_{c}} .$$

The local rotational rate may be determined utilizing the aforementioned equations for most regions of the orientation signal except around the turning points (i.e., the points where the direction of rotation of the optical fiber is reversed). However, the spin rate can be curve fit to a functional form (e.g.,

$$α ( z ) = {α}_{0} cos ( \frac{2 π}{L} z + {φ}_{0} ) + {α}_{off} )$$

using a curve fitting algorithm such as, for example, a best fit algorithm. Once the curve fitting is accomplished, each coefficient of the spin rate can be determined (i.e., the rotational magnitude α₀, the rotational period L, and the rotational offset α_{off}).

Referring again to FIG. 2, once the rotational characteristics of the optical fiber have been calculated based on the orientation signal, the rotational characteristics may be utilized to adjust the rotation of the optical fiber. As described above, PMD is minimized in an optical fiber when the rotational offset is approximately zero. In this condition, the amount of rotation that takes place in the clockwise direction is the same as the amount of rotation that takes place in the counter-clockwise rotation. Accordingly, when the rotational offset is determined to be a non-zero value by the orientation control unit 150, the orientation control unit 150 sends a control signal to the take-up controller 160 indicative of the magnitude of the rotational offset. Utilizing this signal, the controller may adjust the rotation of the optical fiber to decrease the rotational offset and, as such, reduce PMD dispersion in the optical fiber.

It should be understood that the methods for determining the rotational characteristics of the optical fiber described herein may be performed in real time, as the optical fiber is drawn from the optical fiber preform. However, it should also be understood that the methods described herein may be performed offline, such as when the orientation signal is determined in real time as an optical fiber is drawn from an optical fiber preform and analyzed at a later time to determine the rotational characteristics.

It should be understood that the exemplary orientation signals graphically illustrated in FIGS. 6B, 6C and 7 are modeled orientation signals constructed to illustrate the methods for extracting the rotational characteristics of the optical fiber from an orientation signal. In practice, the orientation signals derived from actual optical fibers have significantly more local extrema and some amount of signal noise introduced in the orientation signal during the manufacturing process. Accordingly, it should be understood that, in some embodiments, a Fast Fourier transform may be utilized to reduce the noise in the orientation signal before the orientation signal is analyzed to determine the rotational characteristics of the optical fiber.

### EXAMPLES

The invention will be further clarified by the following examples.

### Example 1

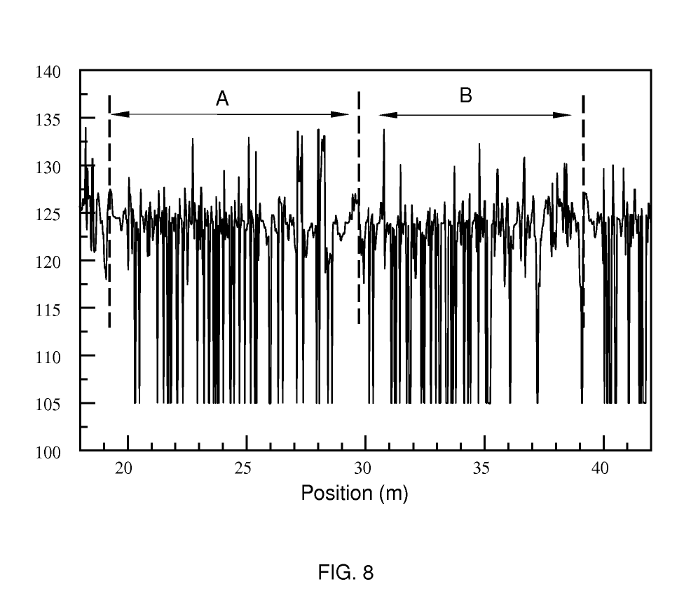

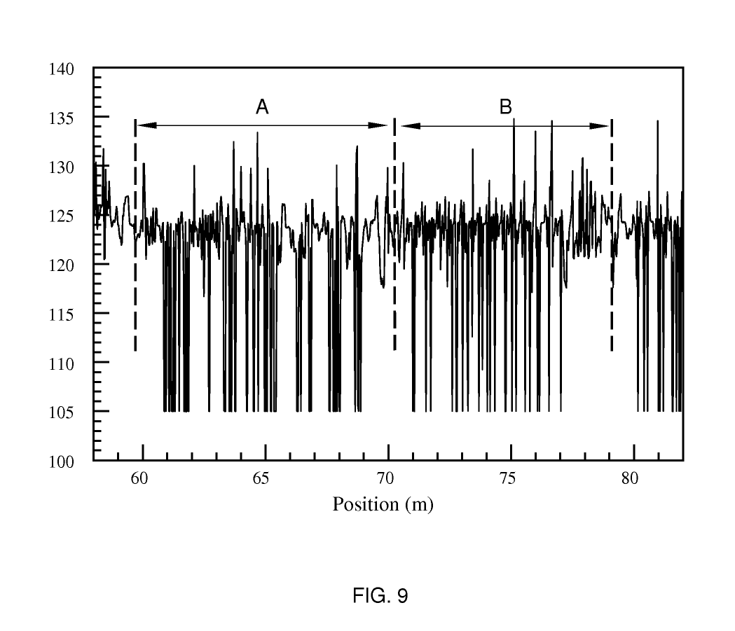

FIGS. 8 and 9 graphically depict orientation signals collected from an optical fiber as the fiber was drawn from an optical fiber preform. An orientation registration feature similar to that depicted in FIG. 1B was formed in an optical fiber preform utilized to manufacture Corning Incorporated's subLEAF optical fiber. The orientation registration feature was formed in the optical fiber preform by trimming two opposing sides of the optical fiber preform such that the resulting orientation registration feature comprised a pair of opposed flats which were roughly parallel with one another such that the optical fiber preform had an aspect ratio of approximately 0.985.

The optical fiber preform was placed in a draw furnace and optical fiber was drawn at a rate of 14 m/s utilizing a draw system similar to that depicted in FIG. 2. The outer diameter of the optical fiber was measured with a laser micrometer. The outer diameter of the optical fiber was collected from the optical fiber at a sampling rate of 500 Hz while the optical fiber was molten. The outer diameter values were collected as a function of the length of the optical fiber to construct an orientation signal for the optical fiber. FIG. 8 depicts the orientation signal derived from a segment of the optical fiber between about 20 meters and 40 meters (i.e., a 20 meter segment) while FIG. 9 depicts the orientation signal derived from the length of optical fiber between about 60 meters and 80 meters (i.e., a different 20 meter segment). The outer diameter of the optical fiber fluctuated between approximately 105 microns and approximately 135 microns in the orientation signals depicted in FIGS. 8 and 9.

It should be noted that FIGS. 8 and 9 indicate the diameter of the optical fiber as a function of the position (length) of the optical fiber as the optical fiber is rotated. However, the diameter measurements in FIGS. 8 and 9 illustrate the change in the diameter of the fiber as the fiber is rotated and do not necessarily depict the actual diameter of the optical fiber (i.e., the diameter measurement is relative to the orientation of the optical fiber).

Once the orientation signals were collected the signals were analyzed according to the methods described above to determine the rotational magnitude of the optical fiber and the rotational offset of the optical fiber. Referring to FIGS. 8 and 9, the rotational period L of the optical fiber was determined to be 20 m for both orientation signatures, the same as the set value for the spin device of the fiber take-up system. Utilizing this rotational period, the first rotational region A and the second rotation region B of each of the orientation signals were determined by identifying the unique signatures in each signal which correspond to a change in the direction of rotation of the optical fiber. These signatures are generally indicated by the dashed vertical lines in each of FIGS. 8 and 9. The number of fringes n_{A} in the first rotational region A and the number of fringes n_{B} in the second rotational region n_{B} were then determined by determining the number of local minima in each of the regions. Thereafter, the rotational magnitude and the rotational offset were determined based on the rotational period L, the number of fringes n_{A} and the number of fringes n_{B}.

Specifically referring to FIG. 8, it was determined that the number of fringes n_{A} in the first rotational region A was 34 and the number of fringes n_{B} in the second rotational region B was 27. Recalling that the rotational period was determined to be 20 meters, the rotational magnitude was calculated to be 2.4 turns/m while the rotational offset was calculated to be 0.17 turns/m.

Specifically referring to FIG. 9, it was determined that the number of fringes n_{A} in the first rotational region A was 33 and the number of fringes n_{B} in the second rotational region B was 25. Recalling that the rotational period was determined to be 20 meters, the rotational magnitude was calculated to be 2.3 turns/m while the rotational offset was calculated to be 0.2 turns/m.

### Example 2

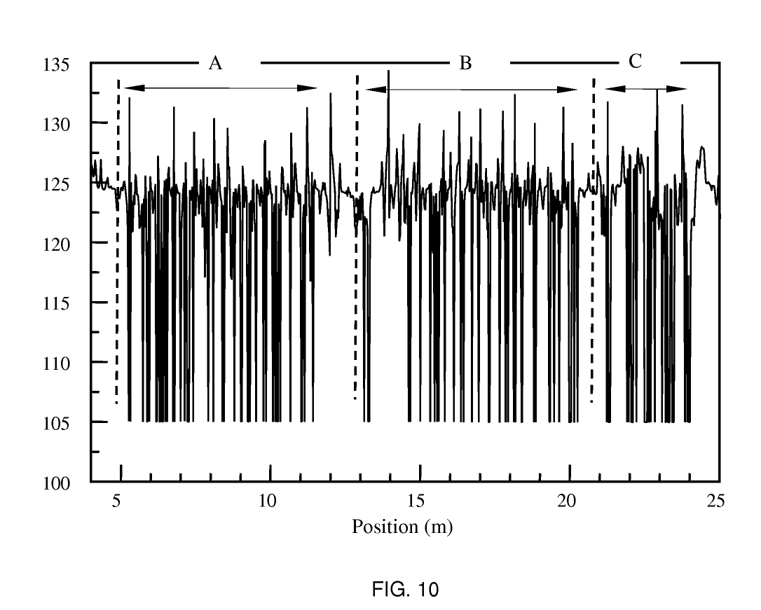

Referring now to FIG. 10, another orientation signal for an optical fiber is graphically depicted. The orientation signal depicted in FIG. 10 was collected from an optical fiber drawn from an optical fiber preform as described above with respect to FIGS. 8 and 9. However, in this embodiment, the orientation signal exhibits three distinct rotational regions: Region A, Region B and Region C. It is hypothesized that Region C is an artifact from the fiber spinning process. For example, Region C may be caused by the fiber contacting an edge of a pulley in the fiber take-up system. The contact is sufficient to temporarily interrupt the rotation of the optical fiber but not sufficient enough to cause a change in the direction of the optical fiber. In the exemplary orientation signal depicted in FIG. 10, the optical fiber is rotated in the same direction in Region A and Region C. Accordingly, for purposes of determining the rotational offset and the rotational magnitude, Region A and Region C may be treated as a continuous region (i.e., Region A+C). In the exemplary orientation signal depicted in FIG. 10, it was determined that the number fringes n_{B} in Region B was 28, the number of fringes n_{A} in Region A was 37, and the number of fringes n_{C} in Region C was 17 such that the number of fringes n_{AC} in Region A+C was 54. The rotational period L was determined to be 20 meters. Accordingly, utilizing the equations defined above, the rotational offset was determined to be 0.65 thus indicating that the methods for determining the rotational characteristics of an optical fiber described herein are sufficiently robust to account for anomalies in the fiber draw process.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of determining a rotational characteristic of an optical fiber comprising:
forming an orientation registration feature in an optical fiber preform;
drawing the optical fiber from the optical fiber preform such that the orientation registration feature formed in the optical fiber preform is imparted to the optical fiber drawn from the optical fiber preform;
rotating the optical fiber about a longitudinal axis of the optical fiber;
periodically reversing a direction of rotation of the optical fiber;
determining an orientation signal of the optical fiber based on a position of the orientation registration feature as the optical fiber is rotated;
determining a first rotational region and a second rotational region;
determining a first number of fringes n_{A} in the first rotational region and a second number of fringes n_{B} in the second rotational region; and
determining the rotational characteristic of the optical fiber based on the first number of fringes n_{A} in the first rotational region and the second number of fringes n_{B} in the second rotational region, wherein the rotational characteristic is at least one of a rotational offset of the optical fiber or a rotational magnitude of the optical fiber.

2. The method of claim 1 further comprising adjusting a rotation of the optical fiber based on the first number of fringes n_{A} and the second number of fringes n_{B}.

3. The method of claim 1 wherein the first number of fringes n_{A} are local minima within the first rotational region and the second number of fringes n_{B} are local minima within the second rotational region.

4. The method of claim 1 wherein the rotational offset is a relative rotational offset.

5. The method of claim 1 wherein the rotational magnitude is a relative rotational magnitude.

6. The method of claim 1 further comprising determining a rotational period L of the optical fiber based on the orientation signal.

7. The method of claim 6 wherein the
$$rotational offset = \frac{\vert {n}_{A} - {n}_{B} \vert}{2 L} .$$

8. The method of claim 6 wherein the
$$rotational magnitude = \frac{π}{4 L} ( {n}_{A} + {n}_{B} ) .$$

9. The method of claim 1 wherein the orientation registration feature is formed in a tapered portion of the optical fiber preform.

10. The method of claim 1 wherein the orientation signal of the optical fiber is determined by measuring a diameter of the optical fiber as the optical fiber is rotated.

11. The method of claim 10 wherein the orientation registration feature formed in the optical fiber is a flat.

12. The method of claim 1 wherein the orientation signal is determined by:
directing a collimated beam of a laser source on to the optical fiber to form diffraction patterns as the optical fiber is rotated; and
collecting the diffraction patterns as a function of a length of the optical fiber.

13. The method of claim 12 wherein the orientation registration feature formed in the optical fiber preform is a groove or a flat.

14. The method of claim 1 further comprising determining a rotational rate of the optical fiber from the orientation signal based on a spacing L_{P} between two adjacent extrema of the orientation signal, wherein the rotational rate=π/L_{P}.

15. The method of claim 1 further comprising determining a rotational rate of the optical fiber from the orientation signal by determining a spacing L_{C} between two adjacent crossing points in the orientation signal, wherein the rotational rate=π/L_{C}.

16. The method of claim 1 wherein the orientation signal of the optical fiber is determined while the optical fiber is molten such that the orientation signal is indicative of the spin imparted to the optical fiber.

17. The method of claim 1 further comprising applying a coating to the optical fiber such that the orientation registration feature of the optical fiber is observable after the coating has been applied, wherein the coating is applied before the orientation signal has been determined.

18. A method of determining a rotational characteristic of an optical fiber comprising:
forming an orientation registration feature in an optical fiber preform;
drawing the optical fiber from the optical fiber preform such that the orientation registration feature formed in the optical fiber preform is imparted to the optical fiber drawn from the optical fiber preform;
rotating the optical fiber about a longitudinal axis of the optical fiber;
periodically reversing a direction of rotation of the optical fiber;
determining an orientation signal of the optical fiber based on a position of the orientation registration feature as the optical fiber is rotated; and
determining a local rotational rate of the optical fiber based on the orientation signal.

19. The method of claim 18 wherein the local rotational rate of the optical fiber is determined by determining a spacing L_{P} between two adjacent extrema of the orientation signal, wherein the local rotational rate=π/L_{P}.

20. The method of claim 18 wherein the local rotational rate is determined by determining a spacing L_{C} between two adjacent crossing points in the orientation signal, wherein the local rotational rate=π/L_{C}.
